(19) United States
(12) Patent Application Publication
(10) Pub. No.: US 2026/0117616 A1
(43) Pub. Date: Apr. 30, 2026

(54) EXPANDABLE CASING PATCH SYSTEM AND METHOD FOR INSTALLING SUCH CASING PATCH

(71) Applicant: UNIARMOUR LLC, Houston, TX (US)

(72) Inventor: Alessandro CACCIALUPI, Houston, TX (US)

(21) Appl. No.: 19/374,126

(22) Filed: Oct. 30, 2025

Related U.S. Application Data
(60) Provisional application No. 63/714,631, filed on Oct. 31, 2024.

(51) Int. Cl. E21B 33/13; E21B 33/128; F16L 55/163

(52) U.S. Cl. CPC E21B 33/13; E21B 33/128; F16L 55/163

(57) ABSTRACT

A casing patch assembly that is deployable within a casing has a pipe with a wide diameter portion and a narrow diameter portion, an expansion cone positioned within the pipe, a plug sealingly engaged against the wide diameter portion of the pipe so as to form a seal, and an anchor having a portion engaged with the inner wall of the wide diameter portion of the pipe. The plug has a first shaft extending through a borehole in the expansion cone and a second shaft adapted to pass a fluid through a channel in the plug so as to urge the expansion cone along the narrow diameter portion of the pipe so as to expand the narrow diameter portion of the pipe.

### CROSS-REFERENCE TO RELATED APPLICATIONS

The present application claims priority from U.S. Provisional Patent Application Ser. No. 64/714,631, filed on Oct. 31, 2024.

### FIELD OF THE INVENTION

The present invention relates to expandable tubulars for oil and gas wells. More particularly, the present invention relates to expandable casing patches employing a pipe with sealing elements for zonal isolation. More particularly, the present invention relates to expandable casing patch systems employing an expansion cone that is propelled by a pressure or force behind the expansion cone.

### BACKGROUND OF THE INVENTION

Oil and gas wells are ordinarily completed by first cementing casing in the hole.

Occasionally, a leak develops at some point in the casing and permits the loss of well fluids to a low pressure, porous zone behind the casing, or permits an unwanted fluid, such as water, to enter the well. It is sometimes necessary to patch a hole or other defect in an oil well pipe, such as a casing or a production tubing, by expanding a malleable liner into sealed engagement with the inside wall of the pipe.

A principal use for liners in wells is to avoid the necessity for running an entire string of smaller casing in a well which already has a larger string of casing. The most common use is in the bottom of the well where the existing casing does not extend to the bottom of the well. In this use, a short liner is lowered to the casing into the bottom of the well where a seal is formed between the liner and the casing to provide a metallic liner in the well to substantially its full depth. In such cases, a seal between the liner and the casing is generally avoided by Portland cement pumped in back of the liner to fill the space between the liner and the casing. Such seals are seldom perfect. As a result, if the pressure of fluids from the formations penetrated by the well is applied to the outside of the liner and casing, a leak usually results. The liner may not be as thick or strong as the casing. When pressure is applied outside the liner and casing, the liner is compressed more than the casing and a crack forms between them even if none existed before. As soon as an opening formed for entrance of fluids between the casing and the liner, the pressures inside and outside the casing tend to become balanced, permitting the casing to return to its unstressed condition. This further widens the opening between the casing and the liner. Since the wider the opening, the more the casing stress is relieved, and since the more the stress is relieved, the wider the opening becomes, it is apparent that a leak between the casing and liner can hardly be avoided even though a long overlap of casing and liner is provided. This problem is particularly acute if it is desired to place a steel liner or patching steel sleeve over a parted casing or a split or hole in the casing. In this case, it is difficult to place Portland cement between the casing and the liner and hold the cement in place until it sets. In addition, the application of pressure outside the liner quickly causes leakage in that manner just described.

Pipe, such as casing or tubing for oil wells, may have variations in the inside wall which reduce or enlarge the inside diameter of the pipe. If such variations are present in an area of the pipe which receives a liner, it is desirable to expand the liner to conform to such variations to provide an effective seal between the liner and the pipe. A difficulty encountered in utilizing liner expanding tools in casing or production tubing is in removing the tool after the tool has been driven through the liner. If there are restrictions in the diameter of the pipe in or above the area covered by the expanded liner, there is more likelihood that the tool may hang up at the restriction and possibly even damage the liner as it is being pulled therethrough.

FIGS. 1A-C show a common expandable casing patch system of the prior art. This casing patch system expands the pipe from the bottom up and utilizes a plug or shoe at the bottom of the expandable pipe that creates a pressure chamber between it and the cone. FIG. 1A illustrates such a system. As can be seen, there is a cone 10, an expandable pipe 12, a shoe 14, a pre-expanded pipe or launcher 16 and seals 18. All of these are deployed in a drill string 20.

FIG. 1B shows that a dart or ball 22 is introduced down the drill string 20. The dart or ball 22 lands on a restriction on the shoe 14. This creates a sealed chamber 24 between the shoe 14 and the cone 10. As such, it seals against the internal face of the expanded face 26 of the pre-expanded pipe or launcher 16. Pressure is then increased to reach expansion pressure. After which, the cone 10 and the string 20 start to travel upwards with the aid of picking up the string 20 at the surface location. Expansion creates a squeeze on the seals 18 between the pipe 12 and the side walls 28. As such, this isolates the problem 30 between the sets of seals 18 and 32. Seals 18 and 32 are circumferential seals that are arranged in multiples on top of and below of the problem area 30.

Referring to FIG. 1C, a major problem associated with the system of the prior art is that the shoe 14 is left behind at the bottom of the expanded pipe 12. As such, it is necessary to drill out the shoe 14 with a bit 32 in order to gain wellbore access. This is not desirable since it adds cost to the production process and also leaves extra debris within the well.

In the past, various patents have issued with respect to such tubular patches. For example, U.S. Pat. No. 5,785,120, issued on Jul. 28, 1998 to Smalley et al., describes a tubular patch system for patching operations and has a body and a series of selectively expandable members, which, once having passed through a tubular of a first diameter, are expandable in a tubular of a second diameter larger than the first diameter. They then operate to expand the liner patch to seal a leak in the tubular of the second diameter. This can be used in a tubular disposed within a wellbore or in a tubular on the surface of the earth.

U.S. Pat. No. 5,829,524, issued on Nov. 3, 1998 to Flanders et al., teaches a high-pressure casing patch which uses one or more fins which elastically flex to accept a casing stub. The casing stub is prepared with a dressing tool containing a special mill to obtain the requisite finish on the outer surface thereof prior to insertion of the casing patch. The flexible fin provides a metal-to-metal seal to the outer surface of the casing patch and a grip assembly holds the joint together. The fins can be combined with a resilient seal where the fins preferably provide a complete extrusion barrier to the resilient seals.

U.S. Pat. No. 7,562,714, issued on Jul. 21, 2009 to G. E. Lynde, shows a casing patch overshot that provides a connection to a stub downhole. A string has a tapered lower end inserted into the stub and expansion occurs from within the tapered lower end into the stub to leave a connection without reduction of the internal diameter. An overshot fitting is lowered outside the stub and the stub is expanded from within against the overshot. These are used to obtain sealing around the inside and outside of the stub. An adjustable swage is used with the overshot configuration.

U.S. Pat. No. 9,587,460, issued on Mar. 7, 2017 to J. G. Clemens, provides a system and method for deploying a casing patch. This casing patch assembly includes a setting kit arranged at an uphole end, an upper wedge portion operatively coupled to the setting kit and defining an upper ramp portion, a lower wedge portion arranged at a downhole end in defining a lower ramp portion, and a casing patch axially interposing the upper and lower wedge portions and having a proximal end configured to radiantly expand upon slidably engaging the upper ramp portion and a distal end configured to radiantly expand upon slidably engaging the lower ramp portion.

U.S. Pat. No. 10,612,349, issued on Apr. 7, 2020 to J. G. Clemens, discloses a casing patch that includes a tubular that has a first end and a second end opposite the first end. Each of the first end and the second end have an expandable wedge that is deformable into a wellbore casing. A locating profile is formed onto the inner surface of the tubular between the first and second ends.

International Publication No. 2012/054445, published on Apr. 26, 2012 to R. M. Whiddon, provides an expandable casing patch that has a housing having an upper end in fluid communication with a source of pressurized fluid and a lower end releasably coupled to an expandable member. A piston is disposed within and sealingly engaged with the housing. An expansion cone is coupled to the piston and is operable to radiantly expand the expandable tubular as it moves longitudinally therethrough. A pressure chamber is disposed within the housing and is defined by the piston and the expansion cone. A first pressure relief port is disposed within the housing and is operable to allow fluid communication between the pressure chamber and an annulus external to the housing. A second pressure relief port is disposed within the expansion cone and is operable to allow fluid communication between the pressure chamber and a portion of the expandable tubular below the expansion cone.

There has long been a need for a casing patch system which is efficient and effective. There has long been a need for such a system, which is insertable through a smaller diameter restriction, tubular, or tubular string into a larger diameter tubular, e.g. casing, which has a leak or hole to be repaired. There has long been a need for such a system that is easily releasable and retrievable, particularly in the event of sticking within a liner patch. There has long been a need for such a system that effectively irons out substantially all of a liner patch.

It is an object of the present invention to provide a casing patch assembly which avoids the need to drill out the shoes following the expansion of the liner.

It is an object of the present invention to provide a casing patch that allows expansion to occur from the top.

It is another object of the present invention to provide a casing patch assembly that removes all tools from the interior of the casing.

It is another object of the present invention to provide a casing patch assembly that effectively seals or patches any leaks or openings in the casing.

It is another object of the present invention to provide a casing patch assembly that is easy to implement.

It is another object of the present invention to provide a casing patch assembly that efficiently installs the patch.

It is still further object of the present invention to provide a casing patch assembly that has reusable components.

These and other objects and advantages of the present invention will become apparent from a reading of the attached specification and appended claims.

### SUMMARY OF THE INVENTION

The present invention is a casing patch assembly that is deployable within a casing. This casing patch assembly has a pipe having a pre-expanded portion at a top thereof so as to define a wide diameter portion of the pipe and a narrow diameter portion of the pipe, and expansion cone positioned within the pipe and having an outer diameter adjacent the wide diameter portion of the pipe, a plug sealingly engaged against the wide diameter portion of the pipe so as to form a liquid-tight seal with an inner wall of the wide diameter portion of the pipe, and an anchor having a portion engaged with an inner wall of the wide diameter portion of the pipe. The expansion cone has a borehole extending longitudinally therethrough. The expansion cone is adapted to move along the pipes so as to expand the narrow diameter portion of the pipe. The plug has a first shaft extending through the borehole of the expansion cone and a second shaft adapted to pass a fluid through a channel in the plug so as to urge the expansion cone along the narrow diameter portion of the pipe. The portion of the anchor extends around a portion of the plug. The anchor is releasably affixed to the second shaft of the plug such that the pipe is expanded and the expansion cone, the plug and the anchor are retrieved through the expanded pipe.

The wide diameter portion of the pipe has a plurality of grooves formed in the inner wall of the pipe. The anchor has a plurality of protrusions received within this plurality of grooves. The plurality of grooves extending axially spaced parallel circumferential relationship around the inner wall of the wide diameter portion of the pipe. The plurality of protrusions can include collets that are releasably engaged with the respective plurality of grooves. The second shaft has a groove formed in an outer diameter thereof. The anchor has a shear screw engaged with this groove of the second shaft. The shear screw is separable from the groove of the second shaft upon a relative movement of the second shaft with respect to the anchor.

A guiding nose is positioned at an end of the narrow diameter portion of the pipe. The first shaft extends through an interior of this guiding nose. The first shaft has an upset at an end thereof. The upset has an outer diameter greater than the diameter of an interior of the guiding nose.

The second shaft has a longitudinal passageway extending therethrough. The channel of the plug branches outwardly of this longitudinal passageway. This channel opens to an interior of the pipe in an area adjacent or above the expansion cone. A ball is received in the longitudinal passageway of the second shaft so as to block the longitudinal passageway such that a fluid is directed from the longitudinal passageway into the channel of the plug.

The present invention is also a method for applying a patch to an inner wall of the casing. This method includes the steps (1) positioning of a pipe within the casing in an area to which the patches to be applied; (2) extending a first shaft through an interior of the casing and through the interior of the pipe; (3) affixing and anchor to an to an inner wall of the wide diameter portion of the pipe into an outer diameter of the second shaft; (4) passing a fluid through a longitudinal passageway of the second shaft and through a channel in the plug so as to pass pressurized fluid into an area behind the expansion cone; and (5) moving the expansion cone through an interior of the pipe such that the expansion cone enlarges the narrow diameter of the pipe such that the patch is placed against the inner wall of the casing. The pipe has a pre-expanded portion of the top thereof such that the pipe has a wide diameter portion and a narrow diameter portion. The pipe has the expansion cone slidably received over an outer diameter of the first shaft. The second shaft has a plug engaged with an inner wall of the wide diameter portion of the pipe.

The method of the present invention includes continuing to move the expansion cone until the expansion cone passes outwardly of an end of the expanded pipe. The anchor is released from the inner wall of the wide diameter portion of the pipe and from the outer diameter of the second shaft. The first and second shaft are retracted so as to remove the expansion cone, anchor and the plug from the interior of the pipe. The anchor is engaged with the pipe by a collet and engaged with the second shaft by a shear screw. The step of releasing includes releasing the collet from engagement with the pipe and breaking the shear screw from engagement with the outer diameter of the second shaft.

A ball is placed in the longitudinal passageway of the second shaft so as to direct the fluid toward the channel of the plug. The first shaft has an upset at an end thereof. This upset has a diameter greater than a diameter of a remainder of the first shaft. The pipe has a guide nose at an end of the narrow diameter portion of the pipe. The step of retracting will include lifting the first and second shafts such that the upset abuts the guide nose so as to draw the guide nose through the expanded interior of the pipe. The step of retracting includes lifting the first and second shaft so as to bring the expansion cone and the plug and the anchor to a surface location.

This foregoing Section is intended to describe, with particularity, the preferred embodiments of the present invention. It is understood that modifications to these preferred embodiments can be made within the scope of the present claims. As such, this Section should not be construed, in any way, as limiting of the broad scope of the present invention. The present invention should only be limited by the following claims and their legal equivalents.

### BRIEF DESCRIPTION OF DRAWINGS

FIGS. 1A-1C are cross-sectional view showing the system and method of the prior art for applying a patch to a casing.

FIG. 2 is a cross-sectional view of the casing patch assembly in accordance with the teachings of the present invention.

FIGS. 3A-3C are step-by-step cross-sectional drawings show the manner in which the casing liner assembly applies the liner to the casing.

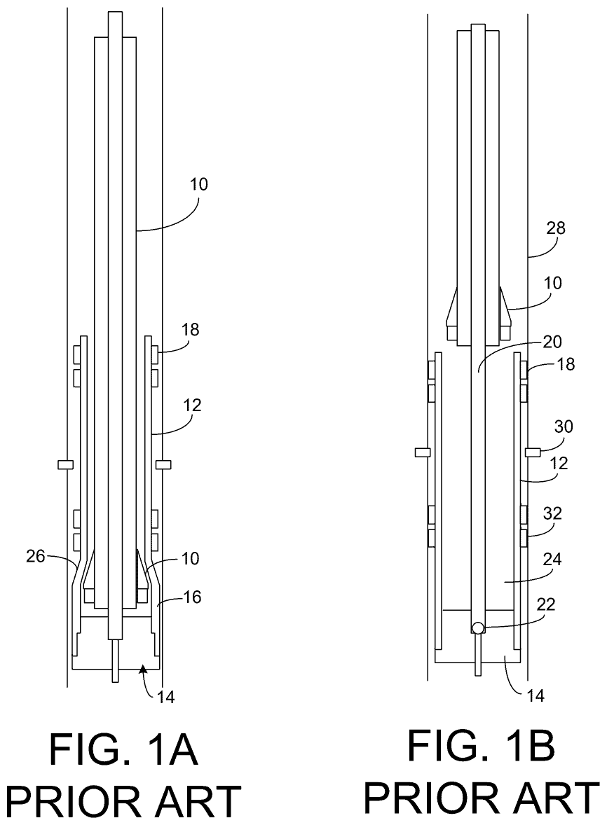

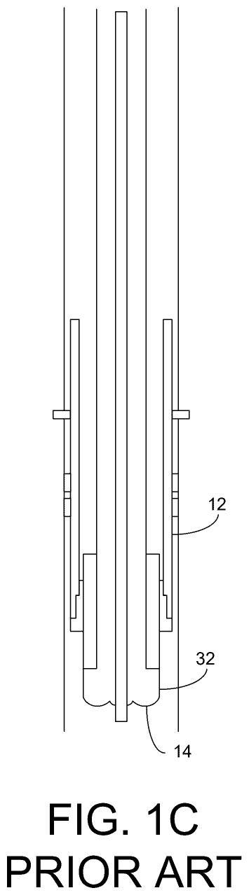

### DETAILED DESCRIPTION OF THE INVENTION

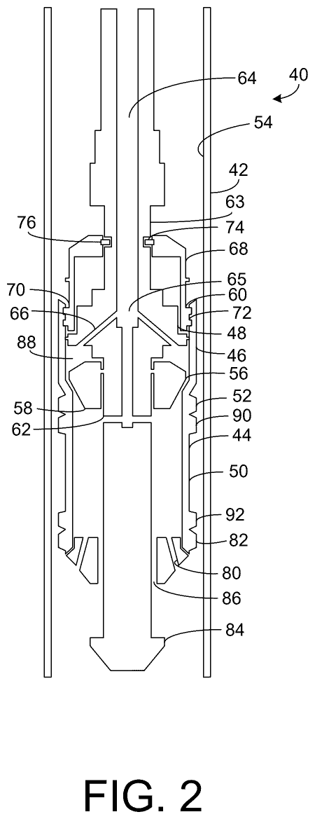

Referring to FIG. 2 shows the casing patch assembly 40 in accordance with the teachings of the present invention. The casing patch assembly 40 is deployable within a casing 42. The casing patch assembly 40 includes a pipe 44 having a pre-expanded portion 46. The pre-expanded portion 46 defines a wide diameter portion 48 and a narrow diameter portion 50 of the pipe 44. A sealing assembly 52 is affixed to an outer diameter of the narrow diameter portion 50 of the pipe 44. The sealing assembly 52 is adapted to seal against an inner wall 54 of the casing 42 when the narrow diameter portion 50 is expanded.

An expansion cone 56 is positioned within the pipe 44 and has an outer diameter adjacent to the wide diameter portion 46 of the pipe 44. The expansion cone 56 has a borehole 58 extending longitudinally therethrough. The expansion cone 56 is adapted to move along the pipe 44 so as to expand the narrow diameter portion 50 of the pipe 44 such that the sealing assembly 52 bears against the inner wall 54 of the casing 42.

A plug 60 is sealingly engaged against the wide diameter portion 48 of the pipe 44 so as to form a liquid-tight seal with an inner wall of the wide diameter portion 48 of the pipe 44. The plug 60 has a first shaft 62 affixed to the plug 60 and extends through the borehole 58 of the expansion cone 56. The plug 60 has a second shaft 63 adapted to pass a pressurized fluid through a longitudinal passageway 64 and into and through a channel 66 of the plug 60. This pressurized fluid serves to urge the expansion cone 56 along the narrow diameter portion 50 of the pipe 44 so as to expand the narrow diameter portion 50 of the pipe 44. An anchor 68 has a portion 70 engaged with an inner wall of the wide diameter portion 48 of the pipe 44. This portion 70 extends around a portion of the plug 60. The anchor 68 is releasably affixed to the second shaft 63.

The wide diameter portion 48 of the pipe 44 has a plurality of grooves 72 formed in an inner wall of the pipe 44. The anchor 68 is illustrated as having a protrusion that is received within these grooves 72. The groove 72 in the wide diameter portion 48 of the pipe 44 actually comprises a plurality of grooves extending in axially spaced parallel relation circumferentially around an inner wall of the wide diameter portion 48 of the pipe 44. The protrusion of the anchor 68 comprises a plurality of protrusions respectively engaged with this plurality of grooves. The plurality of protrusions can be humps positioned at the end of collets fingers that releasably engage with the respective plurality of grooves.

The second shaft 63 has a groove 74 formed in an outer diameter of thereof. The anchor 68 has shear screws 76 engaged with this groove 74 of the second shaft 63. The shear screws 76 are separable from the groove 74 upon a relative movement of the second shaft 63 with respect to the anchor 68.

A guiding nose 80 is positioned at an end 82 of the pipe 44. As seen in FIG. 2, the guide nose 80 actually bears against the end 82 of the narrow diameter portion 50 of the pipe 44. As will be explained hereinafter, when the narrow diameter portion 44 is expanded, the end 82 will be large enough so as to allow the guide nose 80 to pass therethrough and move up through the interior of the pipe 44 and through the interior of the casing 42 to a surface location. The first shaft 62 has an upset 84 at an end thereof. The upset 84 has an outer diameter greater than a diameter of an interior 86 of the guide nose 80.

As can be seen in FIG. 2, the second shaft 63 has the longitudinal passageway 64 for passing the pressurized fluid therethrough. The plug 60 includes channels 66 that branch outwardly from the longitudinal passageway 64. Channels 66 open to an area 88 behind the expansion cone 56. As such, as pressurized fluid is delivered into the area 88, this will urge the expansion cone 56 along the outer diameter of the first shaft 62 so as to expand the pipe 44 such that the sealing assembly 52 will bear against the inner wall 54 of the casing 42 in order to seal against a leak or an opening in the casing.

In order to facilitate the flow from the longitudinal passageway 64 into the channel 66, a ball can be placed into a seat 65 of the longitudinal passageway 64 so as to divert the pressurized fluid into the channel 66.

In FIG. 2, it can further be seen that the seal assembly 52 includes an upper circumferential seal 90 and a lower circumferential seal 92. The upper circumferential seal 90 and the lower circumferential seal 92 are in spaced relation. The upper circumferential seal 90 and the lower circumferential seal 92 are adapted to bear against the inner wall 54 of the casing 42 on opposite sides of a damaged area, a break, or a leak of the casing 42 when the narrow diameter portion 50 of the pipe 44 is expanded by the expansion cone 56.

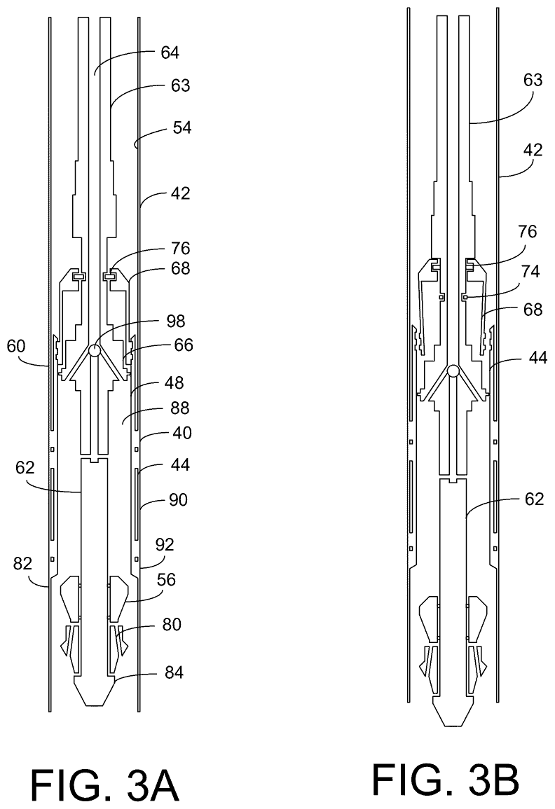

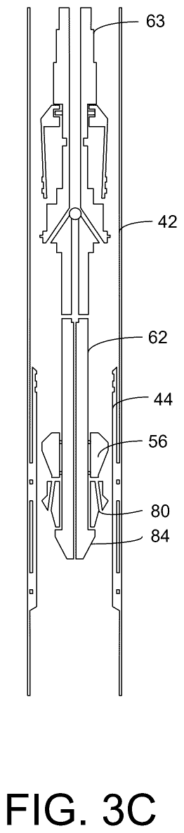

FIGS. 3A-3C show the various steps of the method of the present invention for installing the patch to the inner wall 54 of the casing 42. As can be seen in FIG. 3A, the second shaft 63 is positioned within the well casing 42. The pipe 44 has been expanded by the movement of the expansion cone 56 therealong. As such, the previous narrow diameter portion 50 will have an outer diameter generally matching that of the pre-expanded wide diameter portion 48. This will cause the upper circumferential seal 90 and the lower circumferential seal 92 to bear against the inner wall 54 of the casing 42. It can be seen that the pressurized fluid that passes through the longitudinal passageway 64 of the second shaft 63 flows through the channel 66 and into the area 88 behind the expansion cone 56 so as to force the expansion cone 56 along its path within the pipe 44 in order to carry out the expansion of the pipe 44. Ultimately, the expansion cone 56 will then emerge from the lower end 82 of the pipe 44. The expansion cone 56 will then be positioned against the guide nose 80. The upset 84 will bear against the bottom end of the guide nose 80.

FIG. 3A further shows that there is a ball 98 that has been placed into the seat 65 at the end of the longitudinal passageway 64 so as to divert the pressurized fluid that flows through the longitudinal passageway 64 and into the channel 66.

In the configuration shown in FIG. 3A, the pipe 44 has expanded so that the upper circumferential seal 90 and the lower circumferential seal 92 of the sealing assembly 52 bears against the inner wall 54 of the casing 42 so as to provide an effective seal. This also causes the pipe to have an inner diameter generally matching the inner diameter of the wide diameter portion 48. Also, in this position, it can be seen that the anchor 68 is secured by the shear screw 76 to the outer diameter of the second shaft 63. The collets are also engaged with the grooves formed in the wide diameter portion 48 of the pipe 44. This arrangement of collets and shear screws assures that the anchor 68 is properly secured to the plug 60 during this operation.

FIG. 3B illustrates the next step in the process. It can be seen that the first shaft 62 and second shaft 63 start to be lowered within the casing 42. This causes the shear screw 76 to break away from the groove 74 formed in the outer diameter of the second shaft 63. Similarly, the collets of the anchor 68 will move inwardly so as to separate from those grooves formed in the wide diameter portion of the pipe 44. As a result, this frees the second shaft 63 to move upwardly and outwardly from the casing 42. A subsequent lifting motion will start to occur until the arrangement is achieved in FIG. 3C.

FIG. 3C illustrates that the pipe 44 with its expanded diameter provides an interior diameter that can allow the upset 84 at the end of the first shaft 62 to bear against the guide nose 80. Guide nose 80 will ultimately bear against the expansion cone 56. Each of these components can be lifted through the interior of the pipe 44 and drawn upwardly to a surface location. As such, the patch is effectively established by the placement of the pipe 44 and the various components are effectively removed from the interior of the casing 42. As a result, there is no need to drill out and remove any components that remain within the casing 42.

The foregoing disclosure and description of the invention is illustrative and explanatory thereof. Various changes in the details of the illustrated construction can be made within the scope of the present invention without departing from the true spirit of the invention. The present invention should only be limited by the following claims and their legal equivalents.

1. A casing patch assembly that is deployable within a casing, the casing patch assembly comprising:
a pipe having a pre-expanded portion at a top thereof so as to define a wide diameter portion of said pipe and a narrow diameter portion of said pipe;
an expansion cone positioned within said pipe and having an outer diameter adjacent the wide diameter portion of said pipe, said expansion cone having a borehole extending longitudinally therethrough;
a plug sealingly engaged against the wide diameter portion of said pipe so as to form a liquid-tight seal with an inner wall of the wide diameter portion of said pipe, wherein said plug has a first shaft extending through the borehole of said expansion cone and extending through the narrow diameter portion of said pipe and configured to stop said expansion cone and a second shaft adapted to pass a fluid through a channel in said plug so as to urge said expansion cone along the narrow diameter portion of said pipe; and
an anchor having a portion releasably engaged with an inner wall of the wide diameter portion of said pipe, wherein said pipe is expanded and said expansion cone and said plug and said anchor are retrieved through the expanded pipe.

2. The casing patch assembly of claim 1, the wide diameter portion of said pipe having a plurality of grooves formed in the inner wall of said pipe, said anchor having a plurality of protrusions respectively received within the plurality of groove.

3. The casing patch assembly of claim 2, wherein the plurality of grooves extend in axially spaced parallel circumferential relationship around the inner wall of the wide diameter portion of said pipe.

4. The casing patch assembly of claim 3, wherein the plurality of protrusions comprise collets that releasably engage with the respective plurality of grooves.

5. The casing patch assembly of claim 1, wherein the second shaft has a groove formed at an outer diameter thereof, said anchor having a shear screw engaged with the groove of the second shaft.

6. The casing patch assembly of claim 5, said shear screw being separable from the groove of the second shaft upon a relative movement of the second shaft with respect to said anchor.

7. The casing path assembly of claim 2, wherein said anchor comprises a helical screw engaged win a helical groove inside the inner wall of the wide diameter portion of said pipe.

8. The casing patch assembly of claim 1, further comprising:
a guiding nose positioned at an end of the narrow diameter portion of said pipe, the first shaft extending through an interior of said guiding nose.

9. The casing patch assembly of claim 8, the first shaft having an upset at an end thereof, the upset having an outer diameter greater than a diameter of an interior of said guiding nose.

10. The casing patch assembly of claim 1, wherein the second shaft has a longitudinal passageway extending therethrough, the channel of said plug branching outwardly of the longitudinal passageway, said channel opening to an interior of said pipe in an area behind said expansion cone.

11. The casing patch assembly of claim 9, further comprising:
a ball received in the longitudinal passageway of the second shaft so as to block said longitudinal passageway such that a fluid is directed from the longitudinal passageway into the channel of said plug.

12. A method for applying a patch to an inner wall of a casing, the method comprising:
positioning a pipe within a casing in an area to which the patch is to be applied, the pipe having a pre-expanded portion at a top thereof such that the pipe has a wide diameter portion and a narrow diameter portion;
extending a first shaft through an interior of the casing and through an interior of the pipe, the pipe having an expansion cone slidably received over an outer diameter of the first shaft which is configured to stop the expansion cone, the second shaft having a plug engaged with an inner wall of the wide diameter portion of the pipe;
affixing an anchor to the inner wall of the wide diameter portion of the pipe and to an outer diameter of a second shaft;
passing a fluid through a longitudinal passageway of the second shaft and through a channel in the plug so as to pass pressurized fluid into an area behind the expansion cone; and
moving the expansion cone through an interior of the pipe such that the expansion cone enlarges the narrow diameter of the pipe such that the patch is placed against the inner wall of the casing.

13. The method of claim 12, further comprising:
continuing to move the expansion cone until the expansion cone passes outwardly of an end of the expanded pipe.

14. The method of claim 13, further comprising:
releasing the anchor from the inner wall of the wide diameter portion of the pipe and from the outer diameter of the second shaft; and
retracting the first and second shafts so as to remove the expansion cone and the plug from the interior of the pipe.

15. The method of claim 14, wherein the anchor is engaged with the pipe by a collet and engaged with the shaft by shear screw, the step of releasing comprising:
releasing the collet from engagement with the pipe; and
breaking the shear screw from engagement with the outer diameter of the second shaft.

16. The method of claim 12, further comprising:
placing a ball in the longitudinal passageway of the second shaft so as to direct the fluid toward the channel of the plug.

17. The method of claim 14, wherein the first shaft has an upset at an end thereof, the upset having a diameter greater than a diameter of the remainder of the first shaft, wherein the pipe has a guide nose at an end of the narrow diameter portion of the pipe, the step of retracting comprising:
lifting the first and second shafts such that the upset abuts the guide nose so as to draw the guide nose through the expanded interior of the pipe.

18. The method of claim 14, wherein the step of retracting comprises:
lifting the first and second shafts so as to bring the expansion cone and the plug and the anchor to a surface location.
